(19) United States
(12) Patent Application Publication
(10) Pub. No.: US 2025/0156894 A1
(43) Pub. Date: May 15, 2025

(54) SYSTEM AND METHOD FOR MANAGING CONTENT DELIVERY RELATED TO A PRODUCT

(71) Applicant: Bevflow Inc., La Quinta, CA (US)

(72) Inventor: Evan Phillip Ziegeweid, La Quinta, CA (US)

(73) Assignee: Bevflow Inc., La Quinta, CA (US)

(21) Appl. No.: 18/942,251

(22) Filed: Nov. 8, 2024

Related U.S. Application Data
(60) Provisional application No. 63/548,163, filed on Nov. 10, 2023.
(60) Provisional application No. 63/616,670, filed on Dec. 31, 2023.

(51) Int. Cl. G06Q 30/0238; G06Q 20/20; G06Q 20/38; G06Q 30/0207; G06Q 30/0226

(52) U.S. Cl. CPC G06Q 30/0238; G06Q 20/208; G06Q 20/387; G06Q 30/0224; G06Q 30/0226

(57) ABSTRACT

This disclosure presents a digital marketing platform that enhances consumer engagement at retail points of sale. Using a mobile device, consumers scan a machine-readable code on a product, prompting a central server to deliver targeted video content. An age verification module ensures regulatory compliance, while a discount code is generated post-video viewing, redeemable at checkout. Consumer interactions are recorded to enable personalized recommendations through an artificial intelligence (AI) module that tracks engagement data. The platform also supports post-purchase engagement with secondary videos and additional discounts, encouraging repeat purchases. Seamlessly integrating with both physical and online retail environments, the platform boosts product visibility, facilitates informed decision-making, and links promotional engagement to sales, benefiting both consumers and retailers.

### CROSS REFERENCE TO RELATED APPLICATIONS

This utility patent application claims priority back to U.S. Provisional No. 63/548,163, filed Nov. 10, 2023, and No. 63/616,670, filed Dec. 12, 2023, the contents of which are incorporated by reference into this application.

### STATEMENT REGARDING FEDERALLY SPONSORED RESEARCH OR DEVELOPMENT

This invention was not federally sponsored.

### TECHNICAL FIELD

The present disclosure relates to the field of digital content delivery platforms integrated within retail environments, specifically to systems and methods utilizing machine-readable codes, such as QR codes, barcodes, or NFC tags, affixed to physical products or that product's related print materials such as a rack card or as an addition/modification to an existing retail price tag or product information card. to facilitate consumer engagement. The content delivery platform includes components for scanning, secure content delivery, personalized product-specific video display with supporting product details for quick consumption, discount generation, and video/media consumption related sales tracking with existing and new POS systems within a retail setting, as well as data storage for consumer interactions. The content delivery platform also pertains to artificial intelligence (AI) modules for automated content distribution across multiple channels, enhancing targeted marketing and tracking consumer behavior in both physical and digital points of sale. While the sale of various brands and varieties of wine is used as the example for purposes of illustrating the functionality of the invention, the sales of a wide range of products and services are considered as potential beneficiaries of this method.

### BACKGROUND

In a typical shopping experience, consumers frequently rely on limited information when deciding on a purchase, whether in physical stores or online. For instance, a shopper may enter a store with only a general recollection of product details gathered from previous research, which may not always suffice for informed decision-making. When considering specialty items like wine, where quality and subtle distinctions in flavor profiles vary across brands and vintages, it is challenging for consumers to access detailed product information at the point of sale. Without expert guidance, such as that of a sommelier familiar with specific vineyards and varietals, shoppers have limited resources for further insight, which can impact their confidence in selecting a product that suits their preferences.

Currently, larger vineyards may hesitate to allocate substantial budgets toward advertising campaigns, as the wine consumer market is highly segmented. Even targeted advertisements have limited impact since they often fail to reach the niche audience with an interest in the specific varietal or brand being advertised. For smaller vineyards with fewer economic resources, conducting extensive marketing efforts poses an even greater challenge, making it difficult to connect directly with potential customers or educate them effectively about the unique qualities of their wines. This lack of accessible, tailored information can affect consumer satisfaction and restrict the potential market reach of these producers.

While this situation illustrates a common challenge in the wine industry, the issue extends to any product where consumer knowledge enhances the purchasing experience. Products that benefit from a more informed buying decision—such as premium foods, fine cosmetics, and high-end goods like specialty cheeses or spirits—face similar obstacles in conveying detailed product information directly to the consumer. While we use the sale of wine as an example for purposes of illustration, this system could apply to a wide variety of products.

Consequently, there is a need for an efficient, adaptable platform that facilitates consumer education by providing accessible, relevant product content without the need for external media or information resources that require extra effort for the consumer to locate and consume that information and may not be efficient for the consumer to do so.

### SUMMARY

This summary is provided to introduce concepts related to a system, a method, and a computer-readable medium for managing content delivery related to a product. The concepts are further described below in the detailed description. This summary is not intended to identify key features or essential features of the claimed subject matter, nor is it intended to be used to limit the scope of the claimed subject matter.

The present disclosure envisages a system for managing content delivery related to a product. The system includes a mobile device that scans a machine readable code affixed to a physical product, or that product's related print materials such as a rack card or as an addition/modification to an existing retail price tag or product information card, which initiates communication with a central server. The central server hosts a data storage module to store product-specific content and user interaction data, a video content module to retrieve and stream relevant video content to the mobile device, and an age verification module to authenticate user, and a confirmation of user pre-existing membership phone number to connect the user's eligibility in a loyalty program based on regulatory requirements prior to delivering content. Additionally, the central server features a discount module that generates a unique discount code upon the completion of video viewing, or a direct software connection via API or other system to the retailers Loyalty Program for a specific consumer membership account in the loyalty program, and an artificial intelligence (AI) module that personalizes content distribution in the loyalty program based on observed user behavior. The system further includes a point-of-sale (POS) device configured to redeem these discount codes in association with the loyalty program, thus linking product engagement to purchases.

In an embodiment, the machine-readable code can be a QR code, barcode, or near-field communication (NFC) tag, facilitating seamless interaction between the mobile device and the server.

In an embodiment, the video content module can deliver a secondary video with additional product details after a transaction is completed.

In an embodiment, to enhance product visibility, the AI module distributes product-specific content to third-party platforms in online retail settings.

In an embodiment, the system further includes a session management module that logs session details, such as video viewing duration, user interactions, and generated discount codes, to enable personalized recommendations.

In an embodiment, the POS device links each transaction with the associated video engagement data on the server, allowing for commission tracking based on consumer interaction history and whether a particular consumer is a member of a loyalty program or other retail-driven membership program, while the discount module is designed to consolidate multiple discount codes into a single code for streamlined checkout.

The present disclosure further envisages a method for managing content delivery related to a product. The method begins with a mobile device scanning a machine-readable code associated with the product. This scan prompts a central server to retrieve a product-specific short video from a data storage module and stream it to the mobile device. Upon completion of the video, the central server generates a unique discount code, which is displayed on the mobile device, providing an incentive for the user, or directly connects the users Loyalty Program account with that retailer. The server records user interactions with the video, logging this data into a consumer profile stored on the server. The discount code can then be redeemed at a point-of-sale (POS) device during a transaction involving the product.

Additional features of this method include verifying user eligibility through an age verification module on the server before video streaming to ensure compliance with regulatory requirements. The central server's AI module tracks engagement data and, based on the user's viewing history, generates targeted recommendations for similar products. The generated discount code can also be stored in a loyalty program account linked to the user for future purchases. If no discount code exists, the users Loyalty Program account is connected to the POS system of a retailer, a commission for the video/product content engagement of the user is paid to the platform. Upon video completion, the AI module can issue a follow-up notification prompting additional engagement with related products. After a transaction, the method may further involve generating and displaying a secondary, longer video about the product or a related product, offering deeper insights to the user. If the consumer watches this secondary video, another discount code is generated and added to the user's loyalty program account, enabling future redemption at the POS.

The present disclosure further envisages a non-transitory computer-readable medium storing instructions that, when executed by one or more processors of a system, cause the system to perform a method for managing content delivery related to a product. Initially, the system receives a scan from a mobile device of a machine-readable code associated with the product. This triggers a central server to retrieve product-specific video content from a data storage module and stream it to the mobile device. Before streaming, the system verifies user eligibility through an age verification module to ensure compliance with regulatory requirements. Once the video content is completed, the system generates a unique discount code and transmits it to the mobile device for display. User interactions with the video content are recorded in a consumer profile stored within the data storage module. Additionally, the system stores the discount code in a loyalty program account associated with the user, enabling future redemption at a point-of-sale (POS) device. When the discount code is redeemed during a product transaction, the POS device links the transaction with video engagement data stored in the loyalty program account on the central server. Finally, an artificial intelligence (AI) module tracks user engagement data to generate targeted recommendations for additional products based on the user's past viewing history.

Other and further aspects and features of the disclosure will be evident from reading the following detailed description of the embodiments, which are intended to illustrate, not limit, the present disclosure.

### BRIEF DESCRIPTION OF DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and methods that are consistent with the subject matter as claimed herein, wherein:

FIG. 1 illustrates an exemplary network architecture of a system for managing content delivery related to a product, in accordance with an embodiment of the present disclosure;

FIG. 2 illustrates a block diagram of an exemplary mobile device, in accordance with an embodiment of the present disclosure;

FIG. 3 illustrates an intended point of purchase distribution channels in domestic and international environment, in accordance with an embodiment of the present disclosure;

FIG. 4A illustrates an exemplary implementation of the system in a physical location, in accordance with an embodiment of the present disclosure;

FIG. 4B illustrates a method for managing content delivery related to a product in a physical location, in accordance with an embodiment of the present disclosure;

FIG. 5A illustrates an exemplary implementation of the system in an online platform, in accordance with an embodiment of the present disclosure;

FIG. 5B illustrates a method for managing content delivery related to a product in an online platform, in accordance with an embodiment of the present disclosure; and

FIGS. 6A-6H illustrate sequential views of an exemplary implementation of the system in real time setting, in accordance with an embodiment of the present disclosure.

FIG. 7 illustrates one embodiment of the method of managing content delivery in an online environment, in accordance with an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The detailed description of various exemplary embodiments of the disclosure is described herein with reference to the accompanying drawings. It should be noted that the embodiments are described herein in such details as to clearly communicate the disclosure. However, the amount of details provided herein is not intended to limit the anticipated variations of embodiments; on the contrary, the intention is to cover all modifications, equivalents, and alternatives falling within the spirit and scope of the present disclosure as defined by the appended claims.

It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

The terminology used herein is for the purpose of describing particular embodiments only and is not intended to be limiting of example embodiments. As used herein, the singular forms “a”,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may, in fact, be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

The present disclosure proposes a comprehensive digital marketing platform designed to transform the retail consumer experience by integrating video content delivery, personalized recommendations, and sales incentives within a physical or online point-of-sale environment. The platform leverages machine-readable codes, such as QR codes, NFC tags, or barcodes, which, when scanned by a consumer's mobile device, connect seamlessly to a central server. This server hosts product-specific content, including short promotional videos that provide essential product insights, such as flavor notes for wine or product usage tips for specialty items. Through this immediate access to tailored content, the platform empowers consumers with detailed product information at the moment of decision-making, enhancing their confidence in their purchase choices.

Key components of the platform include an artificial intelligence (AI) module, an age verification module, and a discount generation feature. The AI module processes consumer engagement data to deliver targeted recommendations, adapting content distribution based on individual preferences and past interactions. Additionally, the platform generates unique discount codes as incentives for users who complete video viewings, which can be redeemed at checkout through a point-of-sale (POS) device. This integration of digital engagement with in-store purchasing enables retailers to track consumer interactions, attribute sales to specific marketing efforts, and foster long-term customer loyalty. The platform's versatility across both physical and online environments makes it a valuable tool for enhancing brand visibility, fostering personalized consumer engagement, and driving sales growth in diverse retail settings.

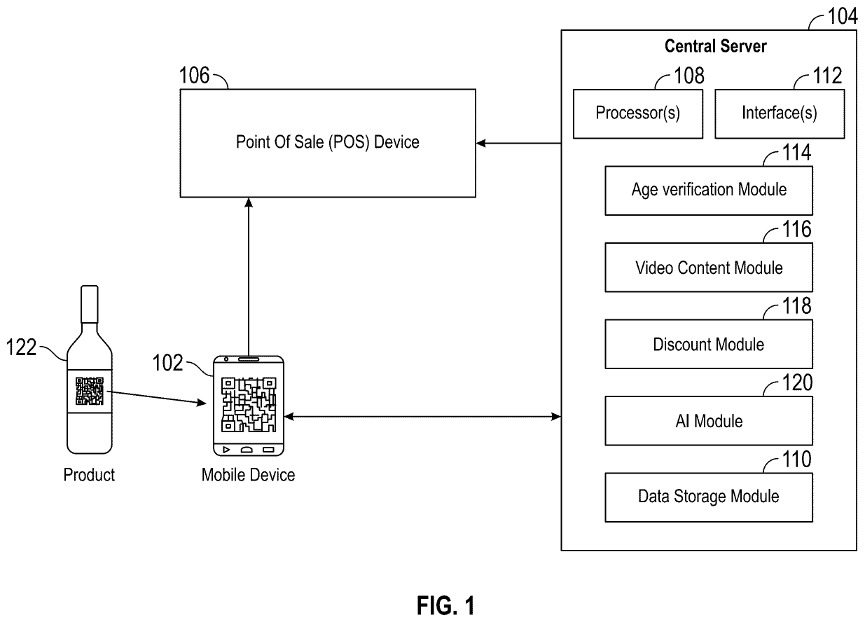

FIG. 1 illustrates exemplary network architecture of a system 100 for managing content delivery related to a product, in accordance with an embodiment of the present disclosure. The system 100 includes a mobile device 102, a central server 104, and a point-of-sale (POS) device 106.

Each of the mobile device 102, the central server 104, and the POS device 106 are connected to each other through a communication network. The communication network may be a wireless network, a wired network or a combination thereof. The communication network may be implemented as one of the different types of networks, such as intranet, Local Area Network (LAN), Wide Area Network (WAN), the Internet, and the like. The communication network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the communication network 106 may include a variety of network devices, including routers, bridges, servers, computing devices, storage devices, and the like.

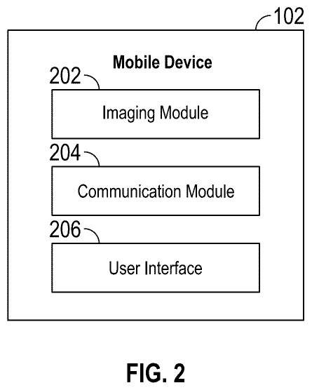

The mobile device 102 may include, but are not limited to, personal digital assistants (PDAs), laptop computers, notebooks, tablets, smart phones, smart cameras, and other handheld smart devices. The mobile device 102 may communicate with other computing devices over the communication network. In an alternative aspect, the present approaches may also be implemented in other types of mobile devices without deviating from the scope of the present disclosure. As can be seen from FIG. 2, the mobile device 102 includes an imaging module 202, including an image scanner or an imaging camera, for scanning a machine readable code affixed to a physical product in a retail environment, selected from a product shelf, promotional display, or restaurant menu. In an embodiment, the machine readable code is selected from a QR code, barcode, or near-field communication (NFC) tag.

Further, the mobile device 102 includes a communication module 204 to extract a communication link from the machine readable code and establish a communication with a custom video player widget embedded on the central server 104 of a retailer. The video player widget is designed to load and play video content seamlessly on a user interface 206 of the mobile device 102 when executed.

Referring back to FIG. 1, the central server 104 is securely communicatively linked to the mobile device 102. The central server 104 includes one or more processor(s) 108. The one or more processor(s) 108 may be implemented as one or more microprocessors, microcomputers, microcontrollers, digital signal processors, central processing units, logic circuitries, and/or any devices that manipulate data based on operational instructions. Among other capabilities, the one or more processor(s) 108 are configured to fetch and execute computer-readable instructions stored in a data storage module 110 of the central server 104. The data storage module 110 may store one or more computer-readable instructions or routines, which may be fetched and executed to create or share the data units over a network service. The data storage module 110 may include any non-transitory storage device including, for example, volatile memory such as RAM, or non-volatile memory such as EPROM, flash memory, and the like.

The central server 104 may also include an interface(s) 112. The interface(s) 112 may include a variety of interfaces, for example, interfaces for data input and output devices, referred to as I/O devices, storage devices, and the like. The interface(s) 112 may facilitate communication of the central server 104 with various devices coupled to the central server 104. The interface(s) 112 may also provide a communication pathway for one or more components of the central server 104. Examples of such components include, but are not limited to, the data storage module 110 and processing modules.

The processing module(s) may be implemented as a combination of hardware and programming (for example, programmable instructions) to implement one or more functionalities of the processing module(s). In examples described herein, such combinations of hardware and programming may be implemented in several different ways. For example, the programming for the processing module(s) may be processor executable instructions stored on a non-transitory machine-readable storage medium and the hardware for the module(s) may include a processing resource (for example, one or more processors), to execute such instructions. In the present examples, the machine-readable storage medium may store instructions that, when executed by the processing resource, implement the processing module(s). In such examples, the central server 104 may include the machine-readable storage medium storing the instructions and the processing resource to execute the instructions, or the machine-readable storage medium may be separate but accessible to central server 104 and the processing resource. In other examples, the processing module(s) may be implemented by electronic circuitry.

In an example, the processing module(s) may include an age verification module 114, a video content module 116, a discount module 118, and an artificial intelligence module 120. The processing module(s) may also include other modules that may implement functionalities that supplement applications or functions performed by the central server 104 or the processing module(s).

The age verification module 114 is configured to ensure that the consumers meet legal requirements for accessing age-restricted content before proceeding with any interaction. The video content module 116 is responsible for storing and streaming product-specific videos, which are tailored to educate and engage the consumers about the products they are considering. Additionally, the discount module 118 generates unique discount codes upon completion of video viewing, encouraging conversions by providing product-specific incentives. The artificial intelligence (AI) module 120 is also integrated into the central server 104, which enhances the distribution and visibility of product-related content across various online and offline retail channels. This AI module 120 may further be used to detect product listings on third-party platforms, embedding or linking the video content within these listings for broader reach.

In operation, as can be seen from FIG. 1, when a consumer engages with the system 100, the process begins with the scanning of a machine-readable code, such as a QR code, NFC tag, or barcode, affixed to a physical product 122 through the mobile device 102. This code triggers the central server 104 to authenticate the user's age, if necessary, and then the video content module 116 streams a pre-recorded short video, typically lasting between 45 to 90 seconds, providing detailed information about the product 122 on the mobile device 102. In an example, the product 122 may include, but not limited to, beverages, luxury goods, beauty products, gourmet foods, and other items.

The short video may be produced by a manufacturer, a third-party content creator, or by the platform itself and is stored on the central server 104 to be deployed across various retail channels. This short video element serves as an educational and promotional tool that provides consumers with detailed insights into the product they are considering, such as tasting notes, production methods, or recommended uses, making it an invaluable asset in the context of high-end products or niche markets.

Following the video, a unique discount code is generated by the discount module 118, which the consumer can use at the point of sale device 106. This interaction is recorded in a consumer's database maintained at the data storage module 110, along with individual preferences and personal details, allowing for personalized recommendations and streamlined future purchases. The consumers can redeem their discounts directly at checkout, with the system 100 utilizing the device's internal registry or phone number for easy recall of prior interactions.

For consumers accessing the system 100 from different devices, such as computers, the central server 100 maintains session information for each interaction, enabling an online-platform to recognize returning users and reissue previously generated discount codes. This design fosters a user-friendly, integrated shopping experience that minimizes the need for repeated registrations while tracking all user interactions to optimize sales and attribute commissions accurately. The central server 104 thus coordinates a cohesive workflow, from age verification and video engagement to discount generation and sales tracking, creating a comprehensive marketing and sales platform tailored to consumer convenience and regulatory compliance.

Further, the central server 104 employs robust security protocols to protect the video content and ensure that only authorized users can access it. The central server infrastructure is based on cloud storage and distribution models, enabling the on-line platform to host a large library of video content without significant limitations on bandwidth or storage capacity. To maintain high levels of performance, the central server 104 includes a content delivery network (CDN) module that accelerates load times and reduces buffering delays, thereby enhancing the consumer's viewing experience. This CDN module distributes video content across multiple nodes globally, ensuring that the video loads efficiently regardless of the consumer's geographic location. Moreover, the central server's architecture is highly scalable, allowing the online-platform to accommodate spikes in usage, particularly during high-demand shopping periods or marketing campaigns.

Further, the integration of the POS device 106 enables seamless tracking of purchases influenced by video interactions. When a consumer decides to purchase a product after viewing the video, the POS device 106 captures the transaction data, linking it to the video engagement tracked by the AI module 120. This linkage enables the system or platform owner to receive a commission on sales influenced by video content, thus creating a sustainable revenue model. The POS device 106 is designed to interface with various retail environments, including both brick-and-mortar stores and online marketplaces. For example, in a physical store, the POS device 106 may recognize the machine readable code interaction as part of the consumer's purchase history, thereby crediting the platform for influencing the sale.

A core feature of the system's software architecture is its ability to personalize the consumer experience. The AI module 120 gathers engagement data, which is then processed by its recommendation engine that suggests similar products or additional content based on the consumer's interests. For instance, if a consumer views a video related to a particular type of wine, the recommendation engine may suggest videos for similar wines or provide information on wines with complementary characteristics. This recommendation engine relies on machine learning algorithms to identify patterns in consumer behavior and generate targeted content, thereby enhancing the relevance and impact of the platform's offerings. The recommendation engine contributes significantly to the technical advancement of the platform by ensuring that consumers receive highly relevant content based on their unique preferences and behaviors.

In an embodiment, the system 100 or the central server 104 further includes a session-management module that tracks each user's interactions in real time. The session-management module records the duration of each viewing session, the specific video accessed, and whether the consumer proceeds to view additional videos or engage with promotional offers. This session data is stored in a user profile database, which accumulates information on each consumer's engagement history and allows the platform to deliver a more personalized experience over time. For instance, if a consumer has a history of viewing videos related to red wines, the platform can prioritize similar content when the consumer next engages with the system. This session-management module also supports user authentication protocols, ensuring that each session is securely tied to the respective consumer without requiring extensive manual input from the user.

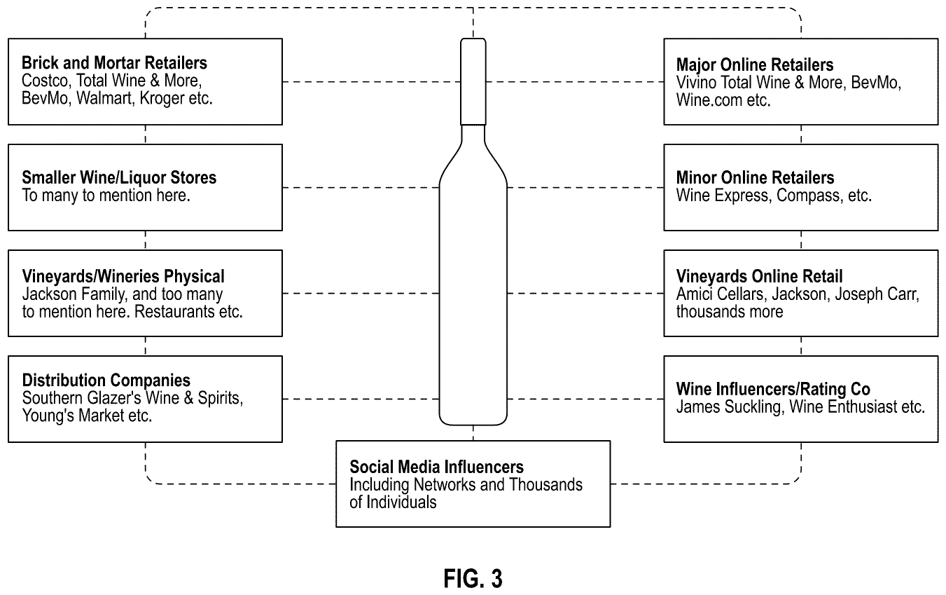

FIG. 3 illustrates an exemplary intended “point of purchase” distribution channels in domestic and international environments, in accordance with an embodiment of the present disclosure. This feature is integral to the system's versatility, enabling brands to implement the platform seamlessly in diverse retail environments, including grocery stores, specialty shops, wine boutiques, and online marketplaces, restaurants and distribution companies. The platform's ability to collect consumer data on video interactions and purchases allows it to personalize future offers and promotions, thereby enhancing the relevance of the brand and marketing efforts. For example, if a consumer frequently views videos related to a particular type of wine, such as cabernet sauvignon, the platform can prioritize content and discounts for similar products, reinforcing brand engagement and driving repeat purchases.

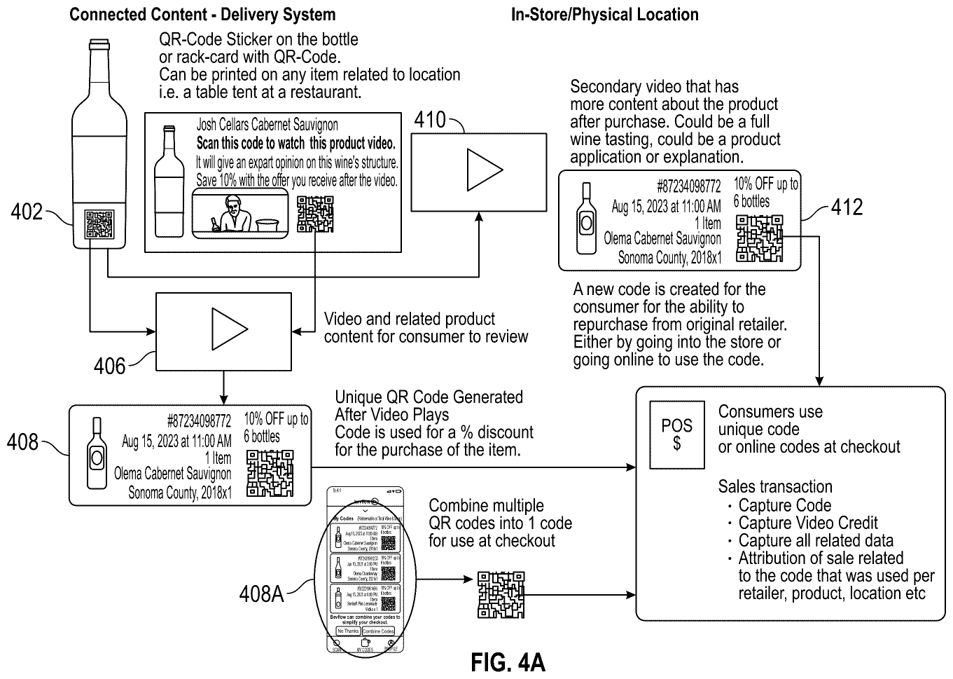

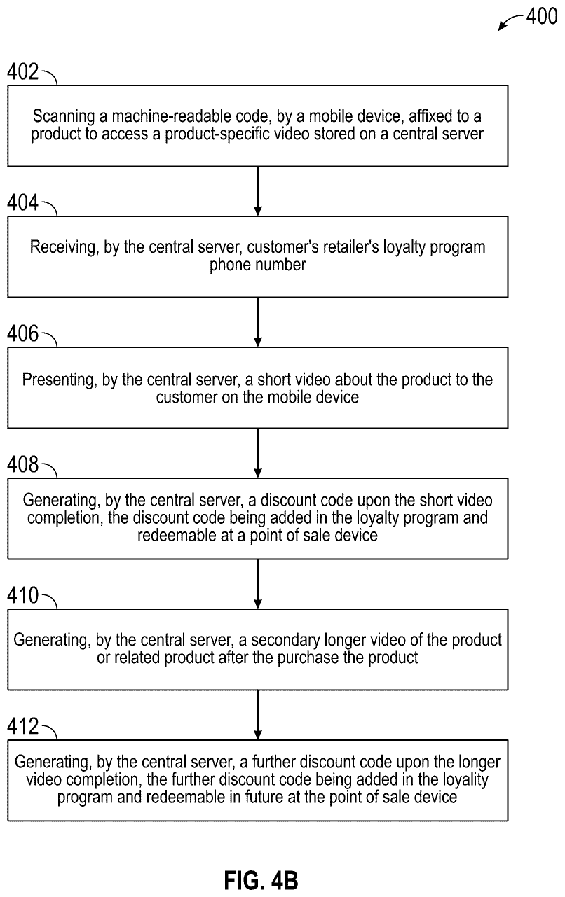

FIGS. 4A and 4B illustrates an exemplary method 400 of managing content delivery in a physical environment, in accordance with an embodiment of the present disclosure. The order in which the method 400 described is not intended to be construed as a limitation, and any number of the described method blocks may be combined in any order to implement the methods, or an alternative method. Furthermore, method 400 may be implemented by processing resource or computing device(s) through any suitable hardware, non-transitory machine readable instructions, or combination thereof.

It may also be understood that method 400 may be performed by programmed computing devices, such as mobile device(s) 102 or a central server 104, or the system 100 as depicted in FIGS. 1-2. Furthermore, the method 400 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The method 400 is described below with reference to computing device(s) as described above; other suitable systems for the execution of these methods may also be utilized. Additionally, implementation of these methods is not limited to such examples.

At step 402, the method 400 begins when a consumer scans a machine readable code affixed to a product 122 using the mobile device 104. In an embodiment, the machine readable code includes, but not limited to, a QR code, barcode, NFC tag, and so forth. This code serves as a gateway to product-specific content, seamlessly linking the physical product to an interactive digital experience. Based on the machine readable code, the mobile device 104 connects to the central server 104 that hosts a product-specific video.

At step 404, the central server 104 prompts the consumer to submit a customer's retailer loyalty program phone number to engage and/or register the offline consumer with the system 100.

At step 406, the central server 104 presents a short video, which is immediately accessible and which offers targeted information and marketing content designed to engage the consumer. The short video, typically lasting between 30 to 90 seconds, provides detailed information about the product 122 on the mobile device 102. Video content of the short video is crafted specifically for the product 122 and is presented directly on the mobile device's screen, for providing an informative and immersive experience that enhances the consumer's understanding of the product. The video content of the short video presented through this method 400 is specifically tailored to be engaging and informative within a concise timeframe, typically between 30 to 90 seconds. This duration is selected to capture and retain consumer attention effectively, delivering key product characteristics and promotional information without overwhelming the viewer. This focused approach ensures that the consumer remains engaged and is more likely to complete the viewing experience, which subsequently triggers the discount code generation.

If the consumer is already a member of a loyalty program, the consumer can enter a phone number or other identifying information and be directed to and connected with the loyalty program of the retailer. This will automatically generate a discount code. As the experience progresses, the system will keep track of videos watched and any pre-existing incentives that are being offered for a particular wine, thereby eliminating the need to generate a discount code.

At step 408, upon completion of the short video, the central server 104 automatically generates a unique discount code as a “reward” for watching the video, which is displayed to the consumer. This discount code is added in the loyalty program and redeemable at the point of sale device 106, offering an incentive for the consumer to complete the purchase of the product 122. This method not only engages the consumer but also captures valuable marketing data; the central server 104 records the consumer's interaction with the video in its data storage module 110. This record contributes to a consumer profile that tracks engagement history and interaction patterns. In cases where the consumer redeems the discount code to purchase the product, a commission is attributed to the platform/system owner, creating a revenue stream linked directly to consumer interactions and sales outcomes facilitated by the digital marketing platform. Sales made under these conditions also reinforce the value of the invention for the retailer using it to generate sales.

At an optional step 408A, for added convenience at the point of sale, the method 400 includes a feature to consolidate multiple discount codes. If a consumer has interacted with several short videos across different sessions, the central server 104 can merge these discount codes into a single master discount code. This consolidation simplifies the checkout process and enhances consumer satisfaction by allowing a streamlined application of accumulated discounts.

At step 410, once the consumer has purchased the product, the central server 104 initiates a secondary engagement step by generating an additional, longer video. This secondary video, created by the central server 104, provides deeper insights into the product or introduces related products, offering more detailed information such as tasting notes or product usage recommendations. This secondary video is designed to engage consumers post-purchase, allowing them to explore further product-related content and, potentially, additional product options. Products featured in this longer video may be automatically added to the consumer's loyalty program account, where they are presented with the best price available from the retailer at the point of sale. This integration with the loyalty program ensures that consumers have an easy path to accessing new offers and discounts for their next purchase, effectively fostering ongoing engagement.

At step 412, upon completing the secondary video, the central server 104 generates a further discount code, which is automatically added to the consumer's loyalty program account. This additional discount code is redeemable in the future, allowing the consumer to receive discounts on subsequent purchases at the point of sale device 106. This method 400 encourages repeat purchases by establishing a continuous engagement loop; after the consumer views the longer video and receives the further discount code, they are prompted to return to the retailer to make additional purchases.

Thus, the central server 104 or the system 100 enables a seamless transition from one purchase to the next, using video content and incentives to foster customer loyalty and build a cycle of engagement that supports ongoing sales and brand connection.

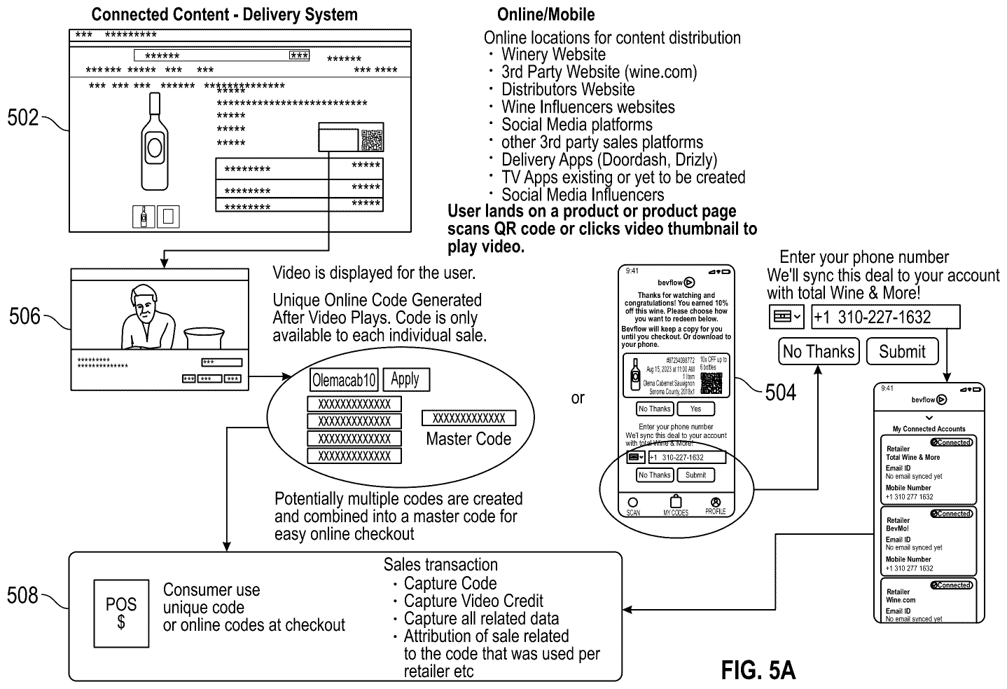

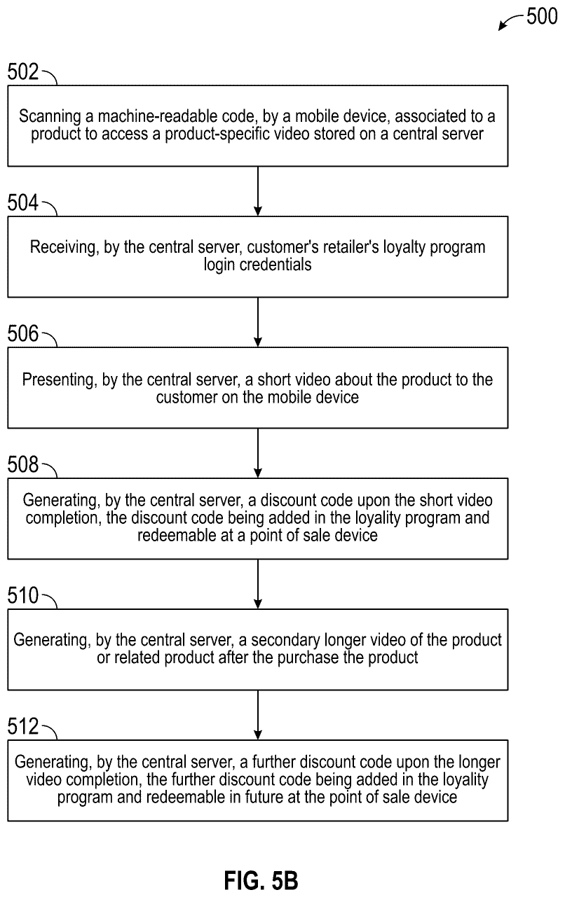

FIGS. 5A and 5B illustrates an exemplary method 500 of managing content delivery in an online environment, in accordance with an embodiment of the present disclosure. The order in which the method 500 described is not intended to be construed as a limitation, and any number of the described method blocks may be combined in any order to implement the methods, or an alternative method. Furthermore, method 500 may be implemented by processing resource or computing device(s) through any suitable hardware, non-transitory machine readable instructions, or combination thereof.

It may also be understood that method 500 may be performed by programmed computing devices, such as mobile device(s) 102 or a central server 104, or the system 100 as depicted in FIGS. 1-2. Furthermore, the method 500 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The method 500 is described below with reference to computing device(s) as described above; other suitable systems for the execution of these methods may also be utilized. Additionally, implementation of these methods is not limited to such examples.

At step 502, the method 500 begins when a consumer scans a machine-readable code, such as a QR code, barcode, NFC tag, a clickable icon or link, etc., associated with a product 122 that is available for sale on an online platform. This method step, performed on the mobile device 102, initiates access to a specific video stored on the central server 104 that provides information and promotional content about the product 122.

At step 504, upon scanning, the central server 104 may receive the consumer's loyalty program login credentials associated with the retailer where the product is being sold, or registers the customer as a new customer with the loyalty program. This method step allows the system 100 to integrate the consumer's interaction within their loyalty program for further engagement and rewards.

At step 506, the central server 104 then presents a short video, of a duration ranging from 30 to 90 seconds, about the product 122 on the consumer's mobile device 102.

At step 508, once the consumer completes watching the shot video, a discount code is generated by the central server 104 as an incentive. This discount code is automatically added to the consumer's loyalty program account, where it becomes redeemable at a point of sale, either online or in-store. To record this interaction and facilitate future engagement, the central server 104 stores data on the consumer's viewing activity in its data storage module 108. Additionally, if the consumer completes a purchase of the product using this discount code, a commission is attributed to the platform owner, rewarding them for driving the sale.

At step 510, following the initial purchase, the central server 104 generates a secondary, longer video about the product or a related product. This longer video provides more in-depth information or promotions, and it may appear within the consumer's loyalty program account to offer them additional product recommendations or updates on the best prices available.

At step 512, if the consumer watches this secondary video, another discount code is generated, which is also added to the loyalty program account for future use at a point of sale. This method step establishes a feedback loop, encouraging the consumer to engage with the product multiple times, benefiting both the retailer and the platform owner.

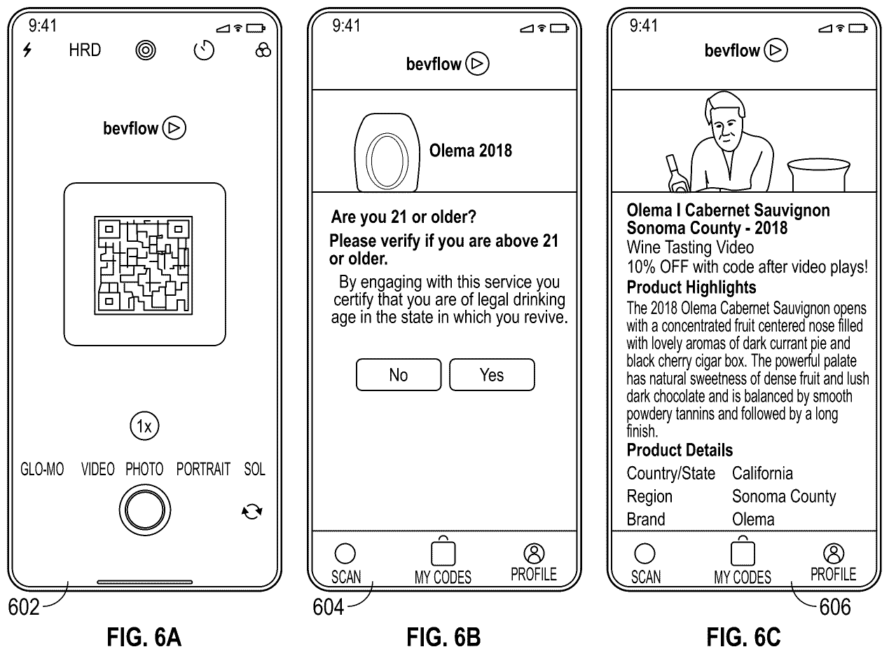

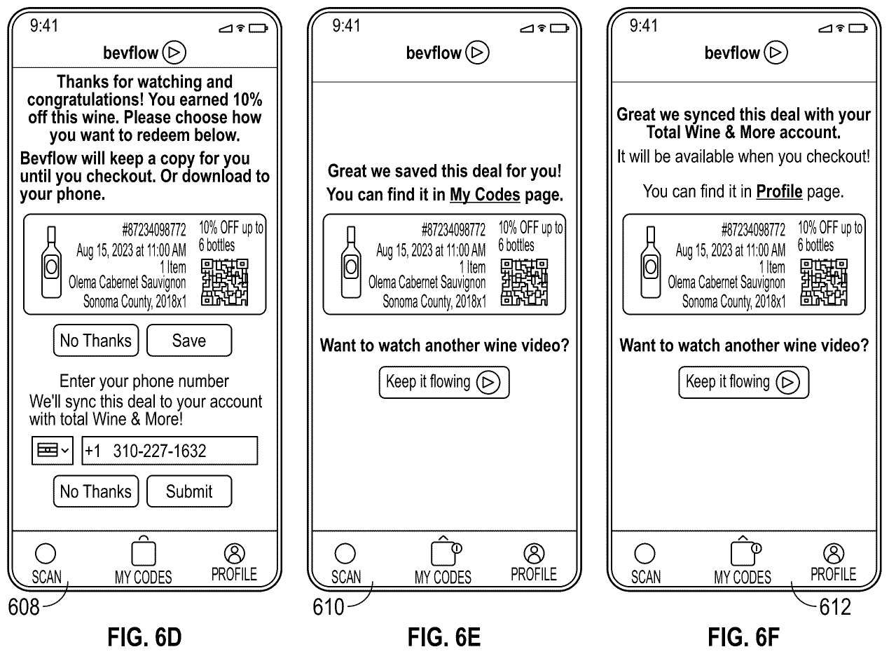

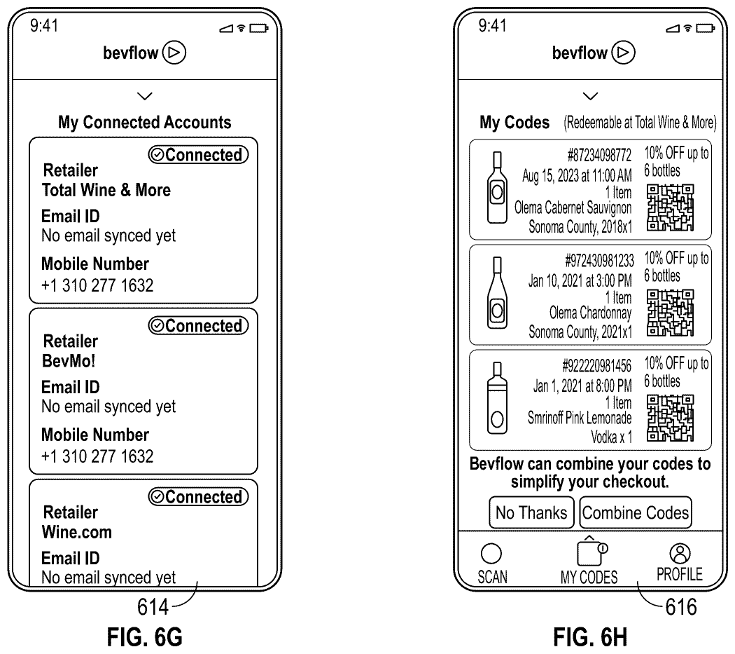

FIGS. 6A-6H illustrate a real-time scenario where the system 100 is implemented in a retail setting, in accordance with an embodiment of the present disclosure. When a consumer scans a QR code on the product (Step 602), the system 100 verifies that the user is of legal purchasing age (Step 604) before proceeding to play the video content (Step 606). Following the video, the system 100 offers a discount (Steps 608, 610, 612) that can be redeemed at checkout (Step 616). The consumer's preferences and personal data are stored within the system's database (614), enabling the system 100 to recommend similar products in the future or provide tailored offers. This personalized data-driven approach enhances the value of the platform by creating a more engaging, customized shopping experience that meets the consumer's individual tastes and needs.

Each feature of the system 100 is designed to operate independently or in conjunction with other features, allowing brands to adopt a platform in a modular fashion according to their specific needs. The system's architecture is adaptable and can be customized to integrate with the technical infrastructure of different retailers and e-commerce sites. The video content associated with each product is easily updated through the platform's server, allowing brands to refresh product information or introduce new content without needing to modify the machine readable codes or links already in circulation. This ensures that the content is always relevant and aligned with the brand's current marketing strategy, providing maximum flexibility and longevity to the platform.

Furthermore, the system 100 includes options for tracking consumer sessions and engagement metrics, such as video completion rates, click-through rates, and conversion metrics. This analytical capability allows brands to measure the effectiveness of their video marketing campaigns and optimize them based on real-world data.

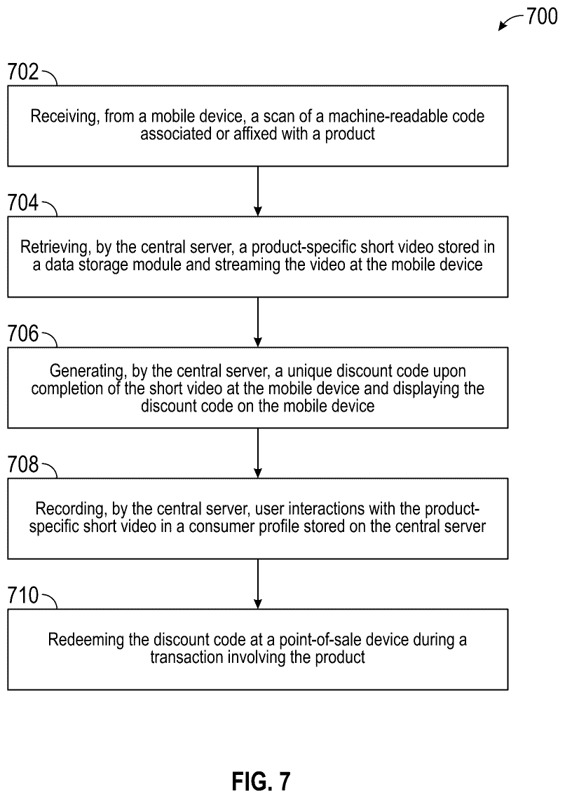

FIG. 7 illustrates an exemplary method 700 of managing content delivery in an online environment, in accordance with an embodiment of the present disclosure. The order in which the method 700 described is not intended to be construed as a limitation, and any number of the described method blocks may be combined in any order to implement the methods, or an alternative method. Furthermore, method 700 may be implemented by processing resources or computing device(s) through any suitable hardware, non-transitory machine readable instructions, or combination thereof.

It may also be understood that method 700 may be performed by programmed computing devices, such as mobile device(s) 102 or central server 104, or the system 100 as depicted in FIGS. 1-2. Furthermore, the method 700 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The method 700 is described below with reference to computing device(s) as described above; other suitable systems for the execution of these methods may also be utilized. Additionally, implementation of these methods is not limited to such examples.

At step 702, the method 700 begins when a consumer scans a machine-readable code, such as a QR code, barcode, NFC tag, or so forth, associated with a product 122 that is available for sale on an online platform. This method step, performed on the mobile device 102, initiates access to a specific video stored on the central server 104 that provides information and promotional content about the product 122.

At step 702, the method 700 begins with receiving, from a mobile device 102, a scan of a machine-readable code, such as a QR code, barcode, NFC tag, or so forth, associated or affixed with a product 122.

At step 704, the method 700 includes retrieving, by a central server 104, a product-specific short video stored in a data storage module 110 and streaming the video at the mobile device 102.

At step 708, the method 700 includes generating, by the central server 104, a unique discount code upon completion of the short video at the mobile device 102 and displaying the discount code on the mobile device 102.

At step 708, the method 700 includes recording, by the central server 104, user interactions with the product-specific short video in a consumer profile stored on the central server 104.

At step 710, the method 700 includes redeeming the discount code at a point-of-sale device 106 during a transaction involving the product 122.

Thus, the present disclosure represents a significant advancement in digital marketing and consumer engagement technologies by integrating a multi-functional platform that bridges the gap between digital content delivery and in-store retail interactions. Traditional retail environments offer limited means for real-time, product-specific consumer engagement, often relying on passive advertisements or static product displays. This system, however, enables direct, interactive communication with consumers through machine-readable codes on product packaging, unlocking immediate access to targeted video content that is personalized and highly relevant to the product of interest. The use of a central server equipped with modules for video streaming, age verification, and discount code generation allows for a seamless, real-time connection between consumers and product information, significantly enhancing their decision-making process at the point of sale.

Additionally, the present disclosure introduces an artificial intelligence (AI) module that analyzes consumer interactions with video content to deliver tailored recommendations. This AI-driven approach not only personalizes the consumer experience but also enables the platform to dynamically adjust its content distribution based on observed engagement patterns. Unlike traditional digital marketing channels, this platform supports in-store consumer behavior tracking and links content engagement directly with product transactions through a point-of-sale (POS) device. This end-to-end integration offers retailers a more effective tool for attributing sales to specific marketing efforts, such as video engagement, and tracking customer preferences over time, thereby creating a feedback loop that continually enhances targeting precision, customer satisfaction, and revenue generation potential.

The system's adaptability is evident in its applicability to a wide range of consumer products beyond beverages. For example, the system 100 can be employed in the marketing of luxury goods, beauty products, gourmet foods, and other items that benefit from in-depth product education at the point of sale. In such scenarios, the platform offers a unique advantage over conventional marketing methods by allowing consumers to access specific, on-demand information that would typically require direct engagement with a knowledgeable sales representative. This increased access to product knowledge enhances consumer confidence and satisfaction, contributing to a more favorable purchasing experience and potentially higher sales conversion rates.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the disclosure, numerous references may be made regarding servers, services, engines, modules, interfaces, portals, platforms, or other systems formed from computing devices. It should be appreciated that the use of such terms are deemed to represent one or more computing devices having at least one processor configured to or programmed to execute software instructions stored on a computer-readable tangible, non-transitory medium or also referred to as a processor-readable medium. For example, a server can include one or more computers operating as a web server, database server, or another type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “receiving,” or “ascertaining,” or “altering,” or “printing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, and each coupled to a computer system bus.

Further, the terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A system for managing content delivery related to a product, comprising:
a mobile device configured to scan a machine-readable code affixed to a physical product;
a central server in communication with the mobile device, the central server comprising:
a data storage module for storing product-specific content and user interaction data,
a video content module configured to retrieve and stream video content associated with the product to the mobile device,
an age verification module to authenticate user eligibility to register in loyalty program based on regulatory requirements before content delivery,
a discount module configured to generate a unique discount code upon completion of video viewing the stream video content,
an artificial intelligence (AI) module to personalize content distribution based on user behaviour in the loyalty program, and
a point-of-sale (POS) device configured to redeem discount codes generated by the central server in association with the loyalty program.

2. The system of claim 1, wherein the machine-readable code comprises a quick response (QR) code, barcode, or near-field communication (NFC) tag to enable connection between the mobile device and the central server.

3. The system of claim 1, wherein the video content module is configured to deliver a secondary video with additional product details upon completion of the transaction associated with the product.

4. The system of claim 1, wherein the AI module distributes product-specific content to third-party platforms to increase product visibility in online retail environments.

5. The system of claim 1, further comprising a session management module on the central server, configured to store session details, including video viewing duration, consumer interactions, and generated discount codes, enabling personalized recommendations.

6. The system of claim 1, wherein the POS device links each product transaction with the video engagement data stored in the central server, allowing commission tracking based on the consumer's interaction history.

7. The system of claim 1, wherein the discount module is configured to consolidate multiple discount codes from different video views into a single code for simplified checkout at the point of sale.

8. A method for managing content delivery related to a product, comprising:
receiving, from a mobile device, a scan of a machine-readable code associated or affixed with a product;
retrieving, by a central server, a product-specific short video stored in a data storage module and streaming the video at the mobile device;
generating, by the central server, a unique discount code upon completion of the short video at the mobile device and displaying the discount code on the mobile device;
recording, by the central server, user interactions with the product-specific short video in a consumer profile stored on the central server; and
redeeming the discount code at a point-of-sale device during a transaction involving the product.

9. The method of claim 8, further comprising verifying, by the central server, user eligibility through an age verification module before video content streaming.

10. The method of claim 8, wherein the AI module of the central server tracks user engagement data and generates targeted recommendations for additional products based on past viewing history.

11. The method of claim 8, wherein the generated discount code is stored in a loyalty program account associated with the user and is redeemable for future purchases.

12. The method of claim 8, further comprises detecting, by the AI module, user viewing completion and issuing a follow-up notification prompting additional engagement with related products.

13. The method of claim 8, further comprises generating and displaying a secondary, longer video about the product or a related product once the transaction related to the product is completed.

14. The method of claim 8, further comprises generating another discount code when the consumer watches the secondary video, and adding this another discount code to a loyalty program account for future use at a point of sale.

15. A non-transitory computer-readable medium storing instructions that, when executed by one or more processors of a system, cause the system to perform a method for managing content delivery related to a product, the method comprising:
receiving, from a mobile device, a scan of a machine-readable code associated with a product;
retrieving, by a central server, product-specific video content stored in a data storage module, and streaming the video content to the mobile device;
verifying user eligibility through an age verification module before streaming the video content;
generating, upon completion of the video content, a unique discount code and transmitting the discount code to the mobile device for display;
recording user interactions with the video content in a consumer profile stored in the data storage module;
storing the discount code in a loyalty program account associated with the user for redemption at a point-of-sale (POS) device;
redeeming the discount code at a point-of-sale device during a product transaction, the point-of-sale device configured to link the transaction with video engagement data stored in the loyalty program account on the central server; and
tracking user engagement data via an artificial intelligence (AI) module to generate targeted recommendations for additional products based on past viewing history.
